(19) United States
(12) Patent Application Publication
(10) Pub. No.: US 2007/0276920 A1
(43) Pub. Date: Nov. 29, 2007

(54) Consistency of routing rules in distributed system landscapes

(76) Inventors: Daniel Buchmann, Pfinztal (DE); Uwe E. Fischer, Karisruhe (DE); Jochen Hoenig, Oehringen (DE); Oliver Scheerer, Nussloch (DE); Bernhard P. Waldscheck, Karlsruhe (DE)

Correspondence Address: FISH & RICHARDSON, P.C., PO BOX 1022, MINNEAPOLIS, MN, 55440-1022, US

(21) Appl. No.: 11/433,602

(22) Filed: May 12, 2006

(51) Int. Cl. G06F 15/16

(52) U.S. Cl. 709/217

(57) ABSTRACT

A directory includes information about various systems (e.g., applications, processes, tasks, objects, services) and data, and may include data ownership information (e.g., data scope, read-write access, master-copy, etc.) and system role information (e.g., consumer or provider role). The directory may define existing systems, corresponding locations by address, and corresponding semantic names. With such information, a service may create routing rules that may provide the requested data via a semantic-based request. The routing rule may be selected to optimize communications and/or response time.

### TECHNICAL FIELD

The subject matter described herein relates to creating and checking routing rules associated with data and/or service requests.

### BACKGROUND

Companies are increasingly adopting multiple applications which run across multiple networks, and which may store data, including objects, in various places across the multiple networks. With conventional systems, the multiple applications must know where relevant data is located. Further, many applications require the use of services that may be accessible locally, but on the other hand, may not be accessible locally, and thus may require some type of remote access. Again, these applications need to know how to find and access such services. This information about where to find relevant data and/or services may be set up manually by a system administrator or the like.

This manual set up is typically embodied in manually configured communication channels between systems having a consumer role (e.g., systems or services that desire data or other services) and systems having a provider role (e.g., systems or services that provide data or other services). Such communication channels may be represented with routing rules and may be defined between pairs of systems, using a central message hub, or the like. As networked systems expand and become larger and more complicated, such manual configuration typically leads to non-optimal results. That is, such manual configuration typically results in some communication links having bottlenecks, some communication links being underutilized, some non-functioning communication links, and some communication links that don't provide the consumer what it really desires or needs. Moreover, because such routing rules are typically manually set up, and done so at a low-level (e.g., at an addressing level rather than at a semantic level), there is no good way to check the consistency of routing rules from a semantic level.

As mentioned above, data and services may reside at various places throughout a networked system. It may become inconvenient for some applications to constantly request data or services that are remotely located. Thus, some applications that require frequent access to particular data sometimes have a local copy of that data available for quick access, while the master data or the “single source of truth” for that data is located remotely, but updated to the local copy of the data periodically in some manner (generally referred to as replication via a subscription process). In such a case, if the application accesses the local copy of the data, it may or may not be the most recent version of that data. That is, the master data may have been changed, but the local copy of data may not yet be updated to reflect that change.

As such, some applications specify that they are to use the master data or the “single source of truth” for that data. That is, some routing rules (e.g., manually configured rules) would typically be configured to specify that the application gets its data from a particular location (i.e., the location of the master data). These routing rules are typically based on lower-level system interfaces and services rather than at higher levels, such as a level that uses semantic naming like a business object level.

If the master data gets relocated to another location in a network, the application may not know of this change and may begin using replicated data without any knowledge thereof. Typically, this would require a system administrator or the like to manually reconfigure a communication channel or routing rule for the application to access the master data or the “single source of truth” for that data. Again, this would typically be configured at lower-level system interfaces and services rather than at higher (e.g., semantic) levels.

### SUMMARY

In one aspect, a directory (which may be a central directory) may include information about various systems (e.g., applications, processes, tasks, objects, services) and data, and may further include data ownership information for various systems and data. The directory may define existing systems, corresponding locations by address, and corresponding semantic names. The directory may also specify the role of each existing system, e.g., a consumer role or a provider role. The role may also include information about the business purpose or business role of the system (and the business information may include semantic information). Also, the directory may include information defining the scope of data that it can provide to other systems. The directory may also specify an access type for each data, e.g., read-only or read-write access, and may specify a level of data quality. With such information, a service may create and check routing rules associated with the provider systems and consumer systems.

For example, an apparatus may check an existing set of routing rules (or even individual routing rules). The apparatus may read a routing rule, from a directory, identifying a consumer system and a corresponding provider system and identifying data to be provided from the provider system to the consumer system; determine, from the directory, if the identified provider system exists; determine, from the directory, a scope of data that the provider system can provide; and determine if the identified data to be provided is within the scope of data that the provider system can provide.

The apparatus may generate a warning message if the identified provider system does not exist according to the directory or may generate a warning message if the identified data to be provided is not within the scope of data that the provider system can provide.

The apparatus may determine, from the directory, if the identified consumer system exists; determine, from the directory, data the consumer system can use; and determine if the identified data matches the data that the consumer system can use. The apparatus may generate a warning message if the identified consumer system does not exist according to the directory and may generate a warning message if the identified data does not match the data that the consumer provider system can use.

The apparatus may determine, from the directory, if the identified provider system can provide a master data for the identified data to be provided and may generate a warning message if the identified provider system cannot provide the master data to be provided. The apparatus may confirm that the routing rule is valid if the identified provider system can provide the master data.

The service may also create and/or check routing rules, for example, at runtime. For example, a data processing apparatus may receive a request for data from a consumer system; determine if the request includes a request for a master data; determine, from a directory, at least one provider system that can provide the requested data to the consumer; determine, from the directory, if a provider system can provide the master data; if the request for data includes a request for a master data and a provider system can provide the master data, then select the provider system that can provide the master data; if the request for data includes a request for a master data and no provider system can provide the master data, then select a provider system from the at least one provider system; and generate a warning that the selected provider system does not provide the master data; and store an identification of the consumer system and an identification of the provider system as a routing rule for providing the requested data.

The apparatus may, if the request for data includes a request for a master data and a provider system cannot provide the master data, select a provider system that cannot provide the master data as single source of truth (but can only provide a replicated copy of the master data). The apparatus may select a provider system from the at least one provider system to optimize communications in a networked system of provider systems and consumer systems, for example by performing load balancing.

The apparatus may receive a request for data from a system, the request including a specification of a type of data access; determine, from a directory containing information indicating roles that systems can perform, a provider system that can provide the requested data; determine, from a directory containing data ownership information about the provider system, whether the provider system can provide the specified type of data access; and store, if the provider system can provide the specified type of data access, an indication of the system, an indication of the requested data, an indication of the type of data access, and an indication of the provider system, as a routing rule.

Computer program products, tangibly embodied in information carriers are also described. Such computer program products may cause a data processing apparatus to conduct one or more operations described herein.

Similarly, systems are also described that may include a processor and a memory coupled to the processor. The memory may encode one or more programs that cause the processor to perform one or more of the operations described herein.

The details of one or more variations of the subject matter described herein are set forth in the accompanying drawings and the description below. Other features of the subject matter described herein will be apparent from the description and drawings, and from the claims.

### DESCRIPTION OF DRAWINGS

FIG. 1 is a schematic diagram illustrating a networked system and an apparatus for accessing data;

FIG. 2 is a process flow diagram illustrating a method for creating a routing rule; and

FIG. 3 is a process flow diagram illustrating a method for checking a routing rule.

Like reference symbols in the various drawings indicate like elements.

### DETAILED DESCRIPTION

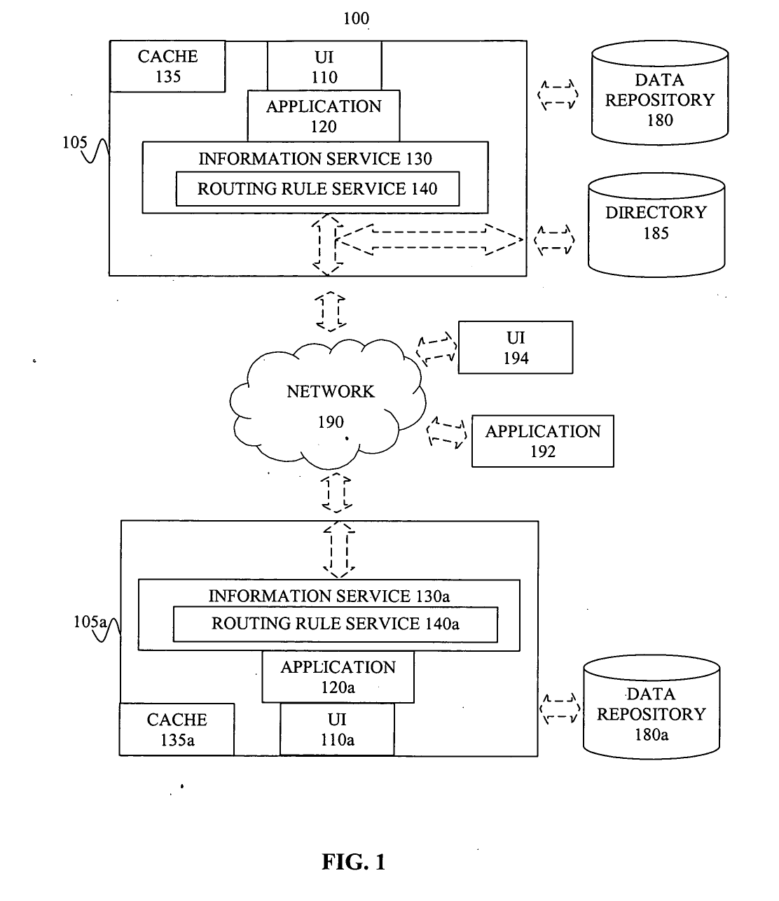

FIG. 1 shows an illustrative networked system 100. As shown, networked system 100 may include a first computing apparatus 105 and a second computing apparatus 105a in communication via network 190. First computing apparatus 105 and second computing apparatus 105a may each be a personal computer, laptop computer, handheld computer, handheld communication device, wireless phone, and the like. Network 190 may be the Internet, a wide area network, a local area network, an Ethernet network, a token-ring network, a wireless network, a wire line network, and the like. Other apparatus may also communicate with first computing apparatus 105 and second computing apparatus 105a, such as, for example, user interface 194 and application 192 executing on another computing apparatus. Moreover, there may be many computing apparatus 105 in communication via network 190.

First computing apparatus 105 may include a user interface 110, which in turn may include a display screen, a keyboard, a mouse, and the like for receiving user input and outputting information to a user. First computing apparatus 105 may also include, or execute, an application 120 in communication with user interface 110. Application 120 may be any application, such as, for example, an enterprise resource planning application, a supply chain management program, an asset management application, a mobile business application, an accounting application, a spreadsheet application, a word processing application, and the like. Second computing apparatus 105a may include a similar user interface 110a and may also include, or execute, a similar application 120a.

First computing apparatus 105 may also include a data repository 180 containing data, including objects, relevant to application 120 and/or to application 120a. Similarly, second computing apparatus 105a may also include a data repository 180a containing data relevant to application 120 and/or to application 120a. As such, with a conventional system, applications 120 and 120a would know or would be able to figure out where data or services is located (e.g., for application 120, whether the relevant data is stored locally in data repository 180 or remotely in data repository 180a).

Data repository 180 may contain data relevant to application 120 executing on first computing apparatus 105 and/or to application 120a executing on second computing apparatus 105a. Likewise, data repository 180a may contain data relevant to application 120 executing on first computing apparatus 105 and/or to application 120a executing on second computing apparatus 105a. Data repository 180 may be integral to first computing apparatus 105, may be directly connected to first computing apparatus 105, e.g., via a USB port and the like, and may also be remotely connected to first computing apparatus 105, e.g., via a network connection and the like (and similarly for data repository 180a with respect to second computing apparatus 105a).

Information service 130 provides an interface between application 120 and the data used by application 120, whether that data resides locally at first computing apparatus 105 or whether that data resides remotely, e.g., at second computing apparatus 105a or the like. In this manner, application 120 may request data via interaction with information service 130 without having to know exactly where the data is located. Information service 130 retrieves or manages the data retrieval of the relevant data for application 120 (and similarly, information service 130a retrieves or manages the data retrieval of the relevant data for application 120a). Thus, information service 130 can manage the retrieval of data locally from data repository 180 or remotely from data repository 180a via network 190. In this manner, application 120 is not burdened with knowing the particular communication protocols (and handling of messaging faults) required for communication over network 190.

To facilitate such retrieval of data, information service 130 is in communication with directory 185 (and similarly for information service 130a with respect to directory 185a), both described in more detail below. Directory 185 is typically a central directory that contains directory information about data. Directory 185, however, for performance reasons or otherwise, may be replicated across the network 190. For example, directory 185 may be replicated to second computing apparatus 105a. While directory 185 is shown as a physically separate data store, directory 185 and data repository may be housed in a single data store or may be distributed among various data stores. Further, a single central information service 130 may be implemented, or multiple distributed information services 130, 130a, etc. may be implemented across networked system 100.

Data from data repository 180 may be replicated to second computing apparatus 105a. That is, if application 120a regularly accesses a particular data from data repository 180, it may make sense, for performance reasons, to replicate that data to a cache 135a in second computing apparatus 105a. Similarly, as shown, it may make sense to replicate data from data repository 180a to a cache 135 in first computing apparatus 105.

Such replication may be implemented via a subscription process that replicates some data, at periodic intervals or otherwise, from one computing apparatus to another. With such replication, the issue arises as whether the replicated data truly represents the master data, i.e., the true current value for that data, (or “single source of truth”).

To assist information service 130, directory 185 may include specific information regarding the data available to the applications 120 in the networked system 100. Such specific information is typically entered during the design-time creation of a data directory that may include multiple dimensions of information describing the data available to other applications. It should be understood, however, that such information may be entered anytime, e.g., during run-time to appropriately update the information.

A first dimension of the directory 185 may define the scope of the data relevant for a particular system (e.g., application, process, task, object, service, and the like). The scope of data may, for example, be a particular object, which may be based on an object type of “Product” of “Business Partner,” for example. The scope of data may also be a portion of an object, for example, address data, or just a single attribute of an object, for example, a zip code. If an object contains sub-instances, the scope of data must be a single sub-instance, multiple sub-instances, or all sub-instances. The scope of data may be defined using negatives, such as “Employee data except for salaries.”

A second dimension of the directory 185 may specify the role of a particular system. The role may be a consumer role or a provider role, for example. A consumer role, for example, may represent that the system is a consumer of data or services. In this case, the directory 185 may also include information that defines the complete set or scope of data that the system uses to perform its function. On the other hand, a provider role may represent, for example, that the system provides data or services to other systems. In this case, the directory 185 may also include information defining the scope of data that it may provide to other systems. The definition may be, for example, a definition that the system will provide data to any other system, that it will provide data to only pre-defined or otherwise enumerated, defined, or determined systems.

The role may also include information about the business purpose or business role of the system. For example, at a high level, the role could include information indicating that the data is associated with a Customer Relationship Management (CRM) application. Further, at a lower level (but still on a business level), the role could indicate which portion of a CRM application the data is associated with (e.g., customer order creation, availability check, etc.). At an even lower level, the role could indicate a particular service interface. The roles typically manifest themselves as software components contained in the system that enable certain processes and services (e.g., business processes and services), but could be implemented in other ways, such as via hardware, etc.

A third dimension of the directory 185 may identify an access type. For example, the directory may identify that a particular provider system may supply read-only access, read-write access, etc.

A fourth dimension of the directory 185 may identify a level of data quality. Thus, the directory may identify, for example, that a particular provider system can provide master data (or the “single source of truth”) or that a particular provider system can only provide replicated data (which may or may not up-to-date with the master data).

With such a directory 185, each system may have defined its relevant data, a set of data it uses to complete its task or function, a definition of the type of access it requests, and a definition of the data quality it desires. Directory 185 may further include information about the location of various data and information about whether and how such data is being replicated to other locations.

With such information available to information service 130, application 120 may at run-time request data or services from information service 130 without specifying the location of the data. Information service 130 may provide the service of retrieving or supplying the requested data or service to application 120, whether the data or service is located locally, remotely, cached locally, cached remotely, or any combination thereof. Application 120 may then access data via a higher level, for example, a business application level, rather than accessing data via the lower level of specifying the data's location. Information service 130 may be implemented centrally on a single computing apparatus or on multiple computing apparatuses, as shown. Further, information service 130 may include a routing rule service 140 which may check and create routing rules for information service 130, as described in more detail below.

Data from data repository 180 may be replicated to second computing apparatus 105a. That is, if application 120a regularly accesses a particular data from data repository 180, it may make sense, for performance reasons, to replicate that data to a cache 135a in second computing apparatus 105a. Similarly, as shown, it may make sense to replicate data from data repository 180a to a cache 135 in first computing apparatus 105.

Such replication may be implemented via a subscription process that replicates some data, at periodic intervals or otherwise, from one computing apparatus to another. Again, with such replication, the issue arises as whether the replicated data truly represents the current data in the master or “single source of truth.”

Directory 185 may be implemented as a proprietary directory (e.g., for a private network) or as a standardized directory (e.g., for an open standardized network or service). Also, directory 185 may also be implemented as multiple directories, some may be implemented as proprietary directories and others may be implemented as standardized directories. Further, the scope of information contained in each directory does not have to be commensurate with all of the other directories. In this manner, directory 185 could offer a full set of services to users on a private network, but offer a more limited set of services to users on a public network, for example.

When a new system is linked to networked system 100, the new system may register itself by providing information about itself to directory 185. In this manner, the addition of a new system could function similarly to a plug and play device. Alternatively, when a new system is linked to networked system 100, a system administrator may register it by providing information about the new system to directory 185.

With such information available to information service 130 and routing rule service 140, application 120 may request data or services from information service 130 and routing rule service 140 without specifying the location of the data. Information service 130 may provide the service of retrieving or supplying the requested data to application 120, whether the data is located locally, remotely, cached locally, cached remotely, or any combination thereof. Application 120 may then access data via a higher level, for example, a business application level, rather than accessing data via the lower level of specifying the data's location. Further, application 120 may do so without concern for protocols, messaging faults, and the like. Also, routing rule service 140 may check and create routing rules. Routing rule service 140 may access services via a higher level, for example, a business application or semantic level, rather than accessing services via the lower level of specifying the service's location. Moreover, routing rule service 140 may store the determined routes, check routes for consistency, and optimize routes as described in more detail below. Information service 130 and routing rule service 140 may be implemented centrally on a single computing apparatus or on multiple computing apparatuses, as shown.

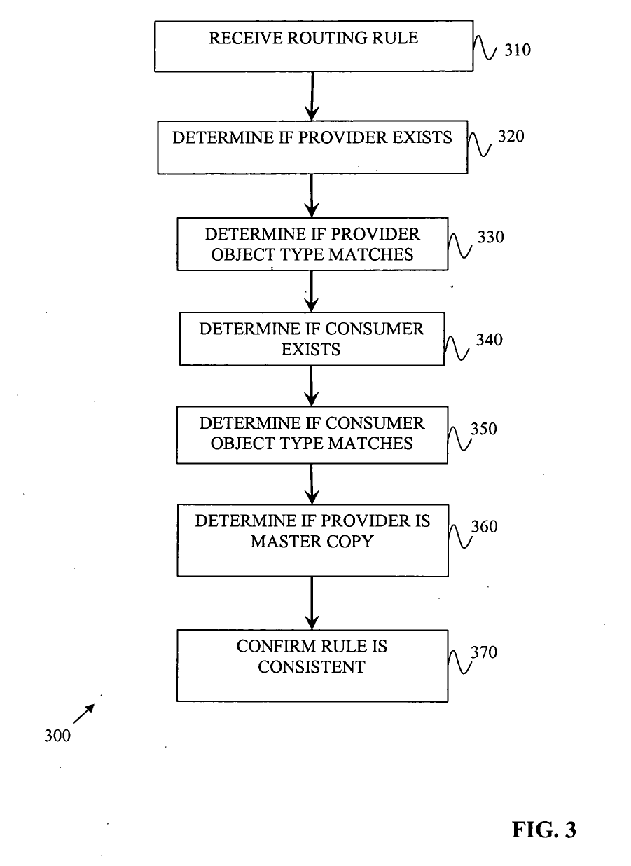

FIG. 3 shows an illustrative method 300 for checking a routing rule. The method of FIG. 3 may be used, for example, to check a set of routing rules which may have been developed manually for a legacy system. The method, however, is not limited to such use and may be used to check any routing rule. As shown at 310, routing rule service 140 receives a routing rule, e.g., by reading from directory 185. The routing rule may define a consumer, a provider, a consumer specification of a service or data, an access type (e.g., read or write access is requested), and a level of data quality (e.g., replicated data is acceptable, or master data is requested).

As shown at 320, routing rule service 140 determines if the provider read at 310 exists. Routing rule service 140 may read directory 185, including the appropriate information from the relevant dimensions in directory 185 to determine if the provider exists. If routing rule service 140 determines that the provider does not exist, then routing rule service 140 issues an error message. If, however, routing rule service 140 determines that the provider exists, then routing rule service 140 proceeds to 330.

As shown at 330, routing rule service 140 determines if the consumer specification of service or data matches the service or data supplied by the provider system determined at 320. Routing rule service 140 may read directory 185, including the appropriate information from the relevant dimensions in directory 185 to determine what services and data the provider determined at 320 can supply. If routing rule service 140 determines that the provider cannot supply the requested type of service or data, then routing rule service 140 issues an error message. If, however, routing rule service 140 determines that the provider can supply the requested service or data, then routing rule service 140 proceeds to 340.

As shown at 340, routing rule service 140 determines if the consumer specified in the routing rule from 310 exists. Routing rule service 140 may read directory 185, including the appropriate dimensions in directory 185 to determine if the consumer exists. If routing rule service 140 determines that the consumer does not exist, then routing rule service 140 issues an error message. If, however, routing rule service 140 determines that the consumer exists, then routing rule service 140 proceeds to 350.

As shown at 350, routing rule service 140 determines if the consumer specification of service or data matches the service or data consumed by the system determined at 310. Routing rule service 140 may read directory 185, including the appropriate information from the relevant dimensions in directory 185 to determine what services and data the consumer uses. If routing rule service 140 determines that the consumer cannot use the requested type of service or data, then routing rule service 140 issues an error message. If, however, routing rule service 140 determines that the consumer can use the requested service or data, then routing rule service 140 proceeds to 360.

As shown at 360, routing rule service 140 determines if the provider specified in the routing rule determined at 310 contains the master data (or single source of truth) for the associated service or data supplied via the routing rule. Routing rule service 140 may read directory 185, including the appropriate dimensions in directory 185 to determine whether the provider contains the master data (or single source of truth) for the associated service or data supplied via the routing rule. If routing rule service 140 determines that the provider does not contain the master data (or single source of truth) for the associated service or data supplied via the routing rule, then routing rule service 140 issues a warning message. If, however, routing rule service 140 determines that the provider contains the master data (or single source of truth) for the associated service or data supplied via the routing rule, then routing rule service 140 confirms the rule is acceptable, as shown at 370.

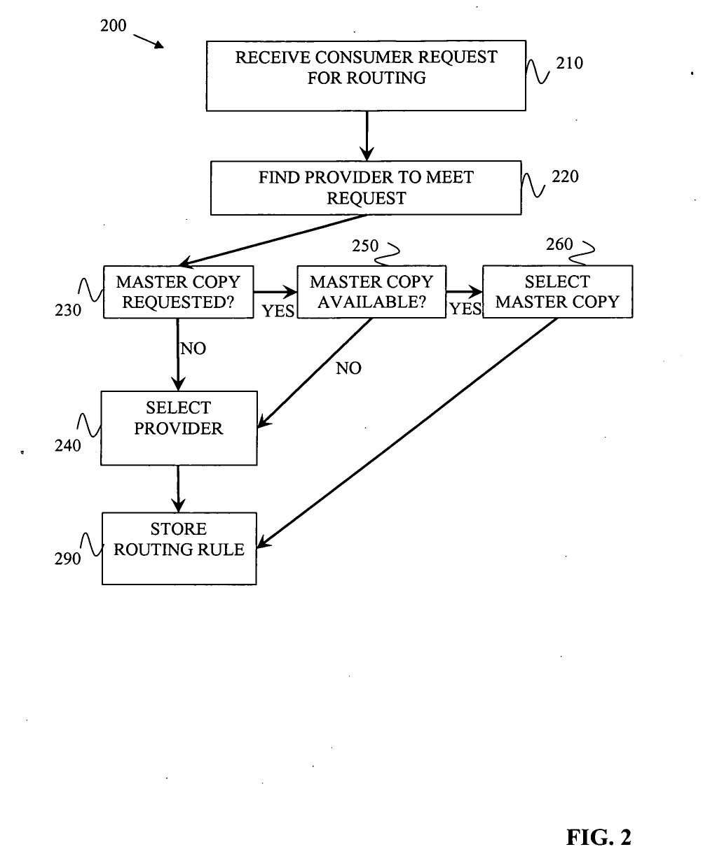

FIG. 2 shows an illustrative method 200 for creating a routing rule. As shown at 210, routing rule service 140 receives a request from a consumer system for a service or for data. While the following description describes routing rule service 140 as performing various functions, it should be understood that information service 130 could perform such functions in place of or in conjunction with routing rule service 130. The request may include a definition of service, a definition of data, and a definition of a scope of data requested. The request may also include a specification of an access type (e.g., read or write access) and a specification of a level of data quality (e.g., replicated data is acceptable, or master data is requested).

As shown at 220, routing rule service 140 determines provider systems that can supply the service or data requested at 210. Routing rule service 140 may read directory 185, including the appropriate dimensions in directory 185 to determine which systems can provide the requested service or data. If routing rule service 140 determines that no provider can supply the requested service or data, then routing rule service 140 issues an error message and may stop processing the request. If, however, routing rule service 140 determines that at least one provider can supply the requested service or data, then routing rule service 140 proceeds to 230.

As shown at 230, routing rule service 140 determines if request received at 210 included a request for the master data or the single source of truth. If the request did not include a request for the master data, then routing rule service 140 proceeds to 240.

As shown at 240, routing rule service 140 selects a provider from the providers determined at 220. Routing rule service 140 may select a provider based on a variety of criteria and may select an optimal provider. The optimal provider may be selected from the consumer's perspective, from an overall network system perspective, or combinations thereof. For example, routing rule service 140 may select a provider that is accessible via a high speed connection, that is currently underutilized in hopes of balancing the overall system load (i.e., load balancing), that is geographically close to the requestor (e.g., the consumer), that is accessible via the least amount of hops, combinations thereof, and the like.

As shown at 290, once routing rule service 140 selects a provider, routing rule service 140 stores the routing rule. The routing rule may include a specification of a consumer, which may be stored at a semantic level, a specification of a provider, which may be stored at a semantic level, a service requested and provided, a data requested and provided, a scope of data requested and provided, an access type requested and provided, a level of quality requested and provided, and routing information, which may be stored at a semantic level, a low-level, both or combinations thereof. The routing rules may be stored in a legacy directory (which typically would not provide for storage of semantic information). Alternatively, the routing rules may be stored in a directory that includes such semantic information which provides the capability of requesting information using semantic names. Such a routing rule directory may include an identification of provider and consumer systems (e.g., IP-address, port number, semantic names, and the like). The semantic information may include business object as well as interface information.

Returning now to 230, if the request included a request for the master data, then routing rule service 140 proceeds to 250. At 250, routing rule service 140 determines if master data (or single source of truth) has been defined for the requested data. Routing rule service 140 may determine if a master data has been defined by reading directory 185.

If routing rule service 140 determines that master data has been defined for the requested data, then the method 200 proceeds to 260 where routing rule service 140 selects the provider that can supply the master data. The method then proceeds to 290, described below.

If, however, at 250, routing rule service 140 determines that no master copy has been defined for the requested data, then routing rule service 140 issues a warning message and proceeds to 240, where routing rule service 140 then selects a provider as described above.

While routing rule service 140 may create a routing rule for a particular request for a service or data, routing rule service 140 may also periodically, or otherwise, check existing routing rules (e.g., stored at 290 described above, manually entered by a system administrator, and the like) to confirm their consistency with the existing configuration of networked system 100 (e.g., as described in directory 185). Such checking of routing rules may help increase routing rule consistency given that the configuration of networked system 100 may continually change, with systems being added, deleted, and modified. Routing rule service 140 may check the consistency of the routing rules with the existing network configuration (and with information stored in directory 185) to determine if selected providers are still existing, are appropriate to meet the consumer's requests, and the like. With conventional systems, this function was typically handled manually be a system administrator.

While the description of methods 200 and 300 above describes application 120 as requesting data or services, the request could come from any system, task, and the like that utilizes data or services. Application 120 may refer to the data without specifying the location of the data. Information service 130 and routing rule 140 may launch agents to process individual or multiple portions of method 200 and 300.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein, do not require the particular order shown, or sequential order, to achieve desirable results. Other embodiments may be within the scope of the following claims.

What is claimed is:

1. A computer program product, tangibly embodied on computer-readable media, the computer program product being operable to cause a data processing apparatus to:
receive a request for data from a consumer system;
determine if the request includes a request for master data;
determine, from a directory, at least one provider system that can provide the requested data to the consumer;
determine, from the directory, if a provider system can provide master data for the requested data;
if the request for data includes a request for master data and a provider system can provide master data for the requested data, then select the provider system that can provide master data for the requested data;
if the request for data includes a request for master data and no provider system can provide master data for the requested data, then
select a provider system from the at least one provider system; and
generate a warning that the selected provider system does not provide master data for the requested data; and
store an identification of the consumer system and an identification of the provider system as a routing rule for providing the requested data.

2. A computer program product as in claim 1, wherein the computer program product is further operable to cause the data processing apparatus to:
if the request for data includes a request for master data and a provider system cannot provide master data for the requested data, then select a provider system that can provide master data for the requested data.

3. A computer program product as in claim 1, wherein the computer program product is further operable to cause the data processing apparatus to:
select a provider system from the at least one provider system to optimize communications in a networked system of provider systems and consumer systems.

4. A computer program product, tangibly embodied on computer-readable media, the computer program product being operable to cause a data processing apparatus to:
read a routing rule, from a directory, identifying a consumer system and a corresponding provider system and identifying data to be provided from the provider system to the consumer system;
determine, from the directory, if the identified provider system exists;
determine, from the directory, a scope of data that the provider system can provide;
determine if the identified data to be provided is within the scope of data that the provider system can provide.

5. A computer program product as in claim 4, wherein the computer program product is further operable to cause the data processing apparatus to:
generate a warning message if the identified provider system does not exist according to the directory.

6. A computer program product as in claim 4, wherein the computer program product is further operable to cause the data processing apparatus to:
generate a warning message if the identified data to be provided is not within the scope of data that the provider system can provide.

7. A computer program product as in claim 4, wherein the computer program product is further operable to cause the data processing apparatus to:
determine, from the directory, if the identified consumer system exists;
determine, from the directory, data the consumer system can use; and
determine if the identified data matches the data that the consumer system can use.

8. A computer program product as in claim 7, wherein the computer program product is further operable to cause the data processing apparatus to:
generate a warning message if the identified consumer system does not exist according to the directory.

9. A computer program product as in claim 7, wherein the computer program product is further operable to cause the data processing apparatus to:
generate a warning message if the identified data does not match the data that the consumer provider system can use.

10. A computer program product as in claim 4, wherein the computer program product is further operable to cause the data processing apparatus to:
determine, from the directory, if the identified provider system can provide master data for the identified data to be provided.

11. A computer program product as in claim 10, wherein the computer program product is further operable to cause the data processing apparatus to:
generate a warning message if the identified provider system cannot provide master data for the identified data to be provided.

12. A computer program product as in claim 10, wherein the computer program product is further operable to cause the data processing apparatus to:
confirm that the routing rule is valid if the identified provider system can provide master data for the identified data to be provided.

13. A computer program product, tangibly embodied on computer-readable media, the computer program product being operable to cause a data processing apparatus to:
receive a request for data from a system, the request including a specification of a type of data access;
determine, from a directory containing information indicating roles that systems can perform, a provider system that can provide the requested data;
determine, from a directory containing data ownership information about the provider system, whether the provider system can provide the specified type of data access; and
store, if the provider system can provide the specified type of data access, an indication of the system, an indication of the requested data, an indication of the type of data access, and an indication of the provider system, as a routing rule.

14. A computer program product as in claim 13, wherein the computer program product is further operable to cause the data processing apparatus to:
store a semantic name for the provider system.

15. A computer program product as in claim 14, wherein the computer program product is further operable to cause the data processing apparatus to:
store an address for the provider system.

16. A computer program product as in claim 13, wherein the computer program product is further operable to cause the data processing apparatus to:
determine, from the directory containing information indicating roles that systems can perform, a plurality of provider systems that can provide the requested data.

17. A computer program product as in claim 16, wherein the computer program product is further operable to cause the data processing apparatus to:
select, from the plurality of provider systems that can provide the requested data, a provider system.

18. A computer program product as in claim 16, wherein the computer program product is further operable to cause the data processing apparatus to:
select, from the plurality of provider systems that can provide the requested data, a provider system that can provide master data for the requested data.

19. A computer program product as in claim 16, wherein the computer program product is further operable to cause the data processing apparatus to:
select, from the plurality of provider systems that can provide the requested data, a provider system that is in communication with the requesting system via an underutilized communication link.

20. A computer program product as in claim 16, wherein the computer program product is further operable to cause the data processing apparatus to:
generate a warning that the selected provider system does not provide master data for the requested data.
